(19) United States
(12) Patent Application Publication
(10) Pub. No.: US 2020/0267016 A1
(43) Pub. Date: Aug. 20, 2020

(54) MANAGEMENT TERMINAL, ELECTRONIC DEVICE, AND MANAGEMENT METHOD OF ELECTRONIC DEVICE

(71) Applicant: SAMSUNG ELECTRONICS CO., LTD., Suwon-si (KR)

(72) Inventor: Seok Min BAEK, Seongnam-si (KR)

(73) Assignee: SAMSUNG ELECTRONICS CO., LTD., Suwon-si (KR)

(21) Appl. No.: 16/757,950

(22) PCT Filed: Oct. 18, 2018
(86) PCT No.: PCT/KR2018/012354

§ 371 Date: Apr. 21, 2020

(30) Foreign Application Priority Data
Oct. 26, 2017 (KR) 10-2017-0140312

(51) Int. Cl. H04L 12/28; H04M 1/725

(52) U.S. Cl. CPC H04L 12/2829; H04M 1/72525; H04M 1/72533

(57) ABSTRACT

A management terminal may include an ID inputter configured to receive an ID of an electronic device from a user; a memory configured to store management information for a plurality of the electronic devices in association with a plurality of the IDs for identifying the plurality of electronic devices, when the management information for the plurality of electronic devices is input; a communication interface connected to at least one of the plurality of electronic devices by wire or wirelessly; and a controller configured to control the communication interface to transmit the management information stored in the memory to the electronic device connected to the communication interface.

### TECHNICAL FIELD

The present disclosure relates to a management terminal capable of integrally managing a plurality of electronic devices, the electronic devices managed by the management terminal and a method of managing the electronic devices.

### BACKGROUND ART

In accommodations such as hotels with multiple rooms or in residential facilities such as multi-family apartments, it is necessary to manage electronic devices such as TVs and computers installed in each room or household. For example, in the case of installing a TV that can connect to a network for each room or household, it is necessary to input information necessary for network settings so that the TVs installed in each of the rooms or households can be connected to a server through the network.

In addition, even in an environment such as an office where multiple computers are used, management such as connecting multiple computers to the network or installing/updating necessary programs for each of the computers is necessary.

### DISCLOSURE

### Technical Problem

The present disclosure provides a management terminal capable of shortening a working time and preventing manual errors by automatically performing tasks such as network settings or program installation and updating of a plurality of electronic devices such as TVs and computers. Also, the present disclosure provides the electronic devices managed by the management terminal and a method of managing the electronic devices.

### Technical Solution

An aspect of the disclosure provides a management terminal including: an ID inputter configured to receive an ID of an electronic device from a user; a memory configured to store management information for a plurality of the electronic devices in association with a plurality of the IDs for identifying the plurality of electronic devices, when the management information for the plurality of electronic devices is input; a communication interface connected to at least one of the plurality of electronic devices by wire or wirelessly; and a controller configured to control the communication interface to transmit the management information stored in the memory to the electronic device connected to the communication interface.

The controller may be configured to search the management information corresponding to the ID input to the ID inputter from the memory.

The communication interface may be configured to transmit the management information corresponding to the input ID to the electronic device connected to the communication interface.

The communication interface may be configured to transmit the management information corresponding to the plurality of IDs and the IDs input to the ID inputter to the electronic device connected to the communication interface.

The management terminal may further include a battery configured to supply power; a power button configured to receive a power on/off command from the user; and an ID recognizer configured to recognize the ID input to the ID inputter.

When the on command is input to the power button, the controller may be configured to control the ID recognizer to recognize the ID input to the ID inputter.

The controller may be configured to search for the management information corresponding to the ID input to the ID inputter in the memory.

When the electronic device is connected to the communication interface, the controller may be configured to control the communication interface to transmit the management information corresponding to the ID input to the ID inputter to the connected electronic device.

When the electronic device is connected to the communication interface, the controller may be configured to control the communication interface to transmit the management information corresponding to the plurality of IDs and the ID input to the ID inputter to the connected electronic device.

The communication interface may include at least one of a wired communication module and a wireless communication module.

The communication interface may include a USB connector that can be inserted into a USB port of the electronic device.

The ID inputter may include at least one of a dial, a button and a touch pad through which numbers or characters can be input.

The management information may include at least one of network settings information used for network settings of the electronic device, a program installed in the electronic device, and information for updating a version of the program installed in the electronic device.

Another aspect of the disclosure provides an electronic device including: a communication interface connected to a management terminal by wire or wirelessly, and configured to request transmission of management information corresponding to a plurality of IDs stored in the management terminal and the ID input to the management terminal; a memory configured to store the management information corresponding to the transmitted plurality of IDs when the management information corresponding to the plurality of IDs is transmitted from the management terminal; and a controller configured to search for the management information corresponding to the IDs input to the management terminal from the memory, and to perform a predefined setting operation based on the searched management information.

The communication interface may include at least one of a wired communication module and a wireless communication module.

The communication interface may include a USB port through which a USB connector of the management terminal is inserted.

The management information may include at least one of network settings information used for network settings of the electronic device, a program installed in the electronic device, and information for updating a version of the program installed in the electronic device.

When the management information corresponding to the plurality of IDs and the IDs input to the management terminal are transmitted from the management terminal, the controller may be configured to output a notification visually or audibly.

Another aspect of the disclosure provides a method of managing an electronic device including: storing management information for a plurality of the electronic devices corresponding to a plurality of IDs identifying the plurality of electronic devices, respectively; receiving the ID of the electronic device from a user; and transmitting the management information including the management information corresponding to the input ID to the electronic device wired or wirelessly connected to a management terminal among the plurality of electronic devices.

The method may further include searching for the management information corresponding to the ID input to an ID inputter among the stored management information.

The transmitting of the management information may include transmitting the management information corresponding to the input ID to the electronic device connected to the management terminal.

The transmitting of the stored management information may include transmitting the management information corresponding to the plurality of IDs and the input ID to the electronic device connected to the management terminal.

The transmitting of the stored management information may include transmitting the stored management information through a USB connector that can be inserted into a USB port of the electronic device.

The management information may include at least one of network settings information used for network settings of the electronic device, the program installed in the electronic device, and information for updating the version of the program installed in the electronic device.

The method may further include recognizing the input ID when the power of the management terminal is on; and searching for the management information corresponding to the ID input to the ID inputter among the stored management information. The transmitting of the stored management information may include transmitting the management information corresponding to the input ID to the electronic device connected to the management terminal.

### Advantageous Effects

According to a management terminal, and an electronic device and a method of managing the electronic device according to the embodiments, it is possible to shorten a working time and prevent manual errors by automatically performing tasks such as network settings or program installation and updating of a plurality of the electronic devices such as TVs or computers.

### DESCRIPTION OF DRAWINGS

FIGS. 1 and 2 are views schematically illustrating a relationship between a management terminal and electronic devices managed by the management terminal according to an embodiment.

FIG. 3 is a control block diagram of a management terminal according to an embodiment.

FIGS. 4 and 5 are external views illustrating an example of a management terminal according to an embodiment.

FIG. 6 is a table illustrating an example of information that may be stored in a memory of a management terminal according to an embodiment.

FIG. 7 is a control block diagram of a management terminal further comprising an ID recognizer.

FIGS. 8 and 9 are views illustrating examples of operations performed by components of a management terminal when the management terminal transmits management information to electronic devices.

FIG. 10 is a control block diagram of a management terminal including a battery.

FIG. 11 is a view illustrating examples of operations performed by components of a management terminal when the management terminal including a battery transmits a file to an electronic device.

FIG. 12 is a view illustrating a case in which an electronic device managed by a management terminal according to an embodiment is a computer.

FIG. 13 is a view illustrating a case in which a management terminal according to an embodiment divides and manages electronic devices into a plurality of groups.

FIG. 14 is a view illustrating another example of a management terminal according to an embodiment.

FIG. 15 is a control block diagram of an electronic device according to an embodiment.

FIG. 16 is a flowchart illustrating an example of a method of managing an electronic device according to an embodiment.

FIGS. 17 and 18 are flowcharts embodying an example of a method of managing an electronic device according to an embodiment.

FIG. 19 is a flowchart illustrating an operation performed by an electronic device in a method of managing the electronic device according to an embodiment.

### MODES OF THE INVENTION

Reference will now be made in detail to exemplary embodiments, with reference to the accompanying drawings. In the drawings, parts irrelevant to the description are omitted to clearly describe the exemplary embodiments, and like numerals refer to like elements throughout the specification. Not all elements of the embodiments of the present disclosure will be described, and the description of what are commonly known in the art or what overlaps each other in the embodiments will be omitted. The terms as used throughout the specification, such as “part,” “module,” “member,” “block,” “unit,” etc., may be implemented in software (e.g., programs, applications, firmware, etc.) and/or hardware (e.g., circuits, microchips, processors, etc.), and a plurality of “parts,” “modules,” “members,” “blocks,” or “units” may be implemented in a single element, or a single “part,” “module,” “member,” “block,” or “unit” may include a plurality of elements.

It will be further understood that the term “connect” or its derivatives refer to either a direct or indirect connection, and the indirect connection includes a connection over a wireless communication network.

The terms “include (or including)” or “comprise (or comprising)” are inclusive or open-ended and do not exclude additional, unrecited elements or method steps, unless otherwise mentioned.

It is to be understood that the singular forms “a,” “an,” and “the” include plural references and vice versa, unless the context clearly dictates otherwise.

Hereinafter, embodiments of a management terminal, and an electronic device and a method of managing the electronic device will be described in detail with reference to the accompanying drawings.

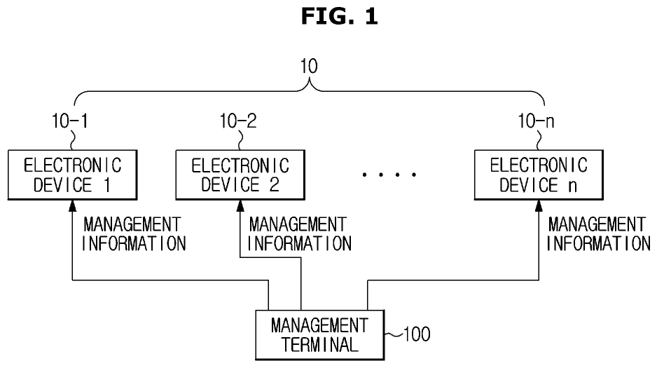

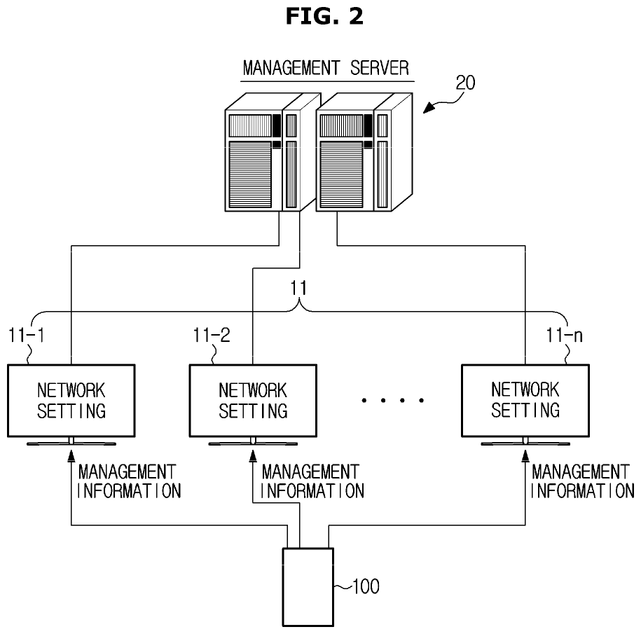

FIGS. 1 and 2 are views schematically illustrating a relationship between a management terminal and electronic devices managed by the management terminal according to an embodiment.

Referring to FIG. 1, a management terminal 100 may collectively manage a plurality of electronic devices 10-1, 10-2, . . . , 10-n (n is an integer greater than or equal to 1).

An electronic device 10 may be connected to the management terminal 100 by wire or wirelessly to receive necessary data from the management terminal 100. For example, the electronic device 10 may receive information necessary for network settings from the management terminal 100 (hereinafter, referred to as ‘network settings information’), a program to be installed in the electronic device 10, and update information of the program installed in the electronic device 10. In the embodiments to be described later, information necessary for management of the electronic device 10 will be referred to as management information.

The management information necessary for each of the electronic devices 10 may be different. The management terminal 100 may store the necessary management information for each of the electronic devices 10 in advance, and may transmit the necessary management information for each of the electronic devices 10.

An electronic device 1 10-1 may transmit the management information stored corresponding to the electronic device 1 10-1, and an electronic device 2 10-2 may transmit the management information stored corresponding to the electronic device 2 10-2. In the same way, the necessary management information may be transmitted to an electronic device n 10-n.

The electronic device 10 may be at least one selected from a group including a display device such as a TV and a computer. In the embodiment, a type of the electronic device 10 that is connected to the management terminal 100 through wired communication or wireless communication and receives necessary data from the management terminal 100 is not limited.

As illustrated in FIG. 2, the electronic device 10 may include a TV 11 installed in each room of accommodations, such as a hotel. There are as many as hundreds to thousands of rooms in the accommodations, and TVs may be installed in each of the rooms. The TVs installed in each of the rooms may be connected to a management server 20 through a network.

A static IP address is assigned to each of the rooms, and when the TVs are connected to the network, network settings information such as the static IP address, a subnet mask, a gateway, and a domain name system (DNS) assigned to each of the rooms must be input to the TVs.

In the past, since the network settings information was inputted manually by an administrator who installs the TVs, a time necessary for a task and a load on the task were increased, which may have led to errors in the input.

The management terminal 100 may match and store the network settings information corresponding to each of the TVs, and may transmit the matched network settings information to each of the TVs. Thus, the network settings information may be automatically input to the TVs.

For example, assuming that n rooms exist in the accommodations and one TV is installed in each of the rooms, a TV installed in a room with a room number of 1 (hereinafter, referred to as ‘Room 1’) may be referred to as TV 1 11-1, a TV installed in a room with a room number of 2 (hereinafter, referred to as ‘Room 2’) may be referred to as TV 2 11-2, and a TV installed in a room with a room number of n (hereinafter, referred to as ‘Room n’) may be referred to as TV n 11-n. Here, the room numbers 1, 2, . . . , n is an example used to distinguish each room from each other, but the number is not meaningful, and in an actual embodiment, other numbers such as 101 and 102 may be used as the room numbers.

In the management terminal 100, the network settings information corresponding to each of the n TVs installed in the n rooms may be stored. When one of the TVs is installed in one of the rooms, each of the TVs may be identified by the room number, and the network settings information may be assigned to each of the rooms.

The management terminal 100 may transmit the network settings information corresponding to the room 1 to the TV 1 11-1, transmit the network settings information corresponding to the room 2 to the TV 2 11-2, and transmit the network settings information corresponding to the room n to the TV n 11-n. When there are four or more of the rooms, the network settings information may be transmitted to the TV installed in the room between the TV 2 11-2 and the TV n 11-n in the same manner.

Each of the TVs 11 may automatically perform network settings based on the transmitted network settings information, and when the network settings is completed, the TVs 11 installed in each of the rooms may access the management server 20 through the network.

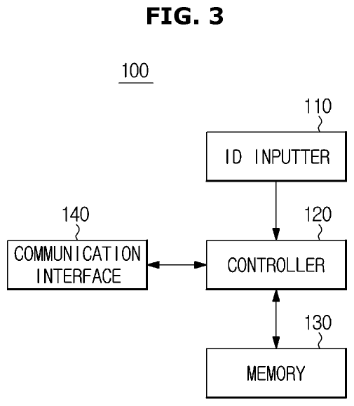

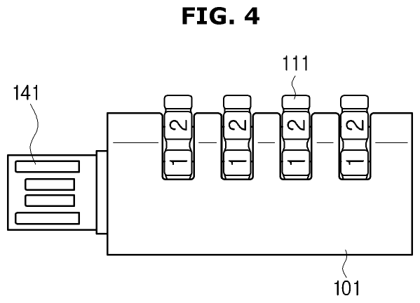

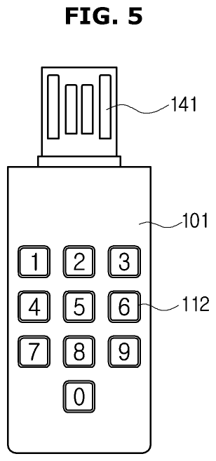

FIG. 3 is a control block diagram of a management terminal according to an embodiment, and FIGS. 4 and 5 are external views illustrating an example of a management terminal according to an embodiment.

Referring to FIG. 3, the management terminal 100 may include an ID inputter 110 that receives an ID of the electronic device 10 from a user, a memory 130 that stores the management information for the plurality of electronic devices 10 in correspondence with a plurality of the IDs identifying the plurality of electronic devices 10, respectively, when the management information for the plurality of electronic devices 10 is input or received, a communication interface 140 that is connected to the electronic device 10 by wire or wirelessly, and a controller 120 that controls the communication interface 140 to transmit the management information stored in the memory 130 to the electronic device 10. In the embodiment, the user may include the administrator who manages the electronic device 10 using the management terminal 100.

The ID of the electronic device 10 input to the ID inputter 110 may be information provided to distinguish the plurality of electronic devices 10 from each other, and may be information assigned to the electronic device 10 itself or information identifying a space in which the electronic device 10 is located. In the latter case, the ID may be the number of the room in which the electronic device 10 is located. The ID input to the ID inputter 110 may be information that distinguishes the electronic device 10 and matches and stores the management information corresponding to each of the electronic devices 10, and does not limit the type.

The ID inputter 110 may be implemented in various forms, such as a button form, a dial form, and a touch pad form for inputting numbers or characters. A specific implementation example of the ID inputter 110 will be described later.

The memory 130 may match and store the management information corresponding to each of the electronic devices 10. Here, the management information corresponding to each of the electronic devices 10 may be information necessary for management of the corresponding electronic device 10, and may include at least one of various setting information including the network settings information necessary for network connection of the electronic device 10, a program to be installed in the electronic device 10, and update information of the program installed in the electronic device 10. The management information may be information necessary for management of each of the electronic devices 10 and may be stored in advance in the memory 130 of the management terminal 100. If it is a type that can be transmitted from the management terminal 100 to the electronic device 10, it may be the management information corresponding to the electronic device 10 in the embodiment.

When the memory 130 matches and stores information corresponding to each of the electronic devices 10, each of the electronic devices 10 may be identified by the ID. That is, the management information corresponding to each of the electronic devices 10 may be matched with the ID of the corresponding electronic device 10 and stored.

The memory 130 may include a non-volatile memory in which data is not lost even when the power is cut off. For example, the memory 130 may include flash memory. It is also possible that the memory 130 may further include a volatile memory for temporarily storing data as necessary. The volatile memory may store the temporarily necessary data for data processing or calculation.

The controller 120 may receive the ID input by the user from the ID inputter 110 and search for the management information corresponding to the ID input from the memory 130. The controller 120 may control the communication interface 140 to transmit the searched management information to the electronic device 10.

Alternatively, it is also possible for the controller 120 to transmit the management information corresponding to the entirely of IDs stored in the memory 130, that is, full management information and the ID input to the ID inputter 110 to the communication interface 140 to be transmitted to the electronic device 10. In the latter case, the electronic device 10, which has received the full management information and its ID, may extract the management information corresponding to the ID from the full management information and perform predetermined operations such as network settings, program installation, and version update.

In addition, the controller 120 may control the overall operation of the management terminal 100. When the management information is input through the communication interface 140, the input management information may be stored in the memory 130. When a request for information is input through the communication interface 140, the requested information may be searched from the memory 130 and transmitted through the communication interface 140. That is, the controller 120 may control an operation in which the memory 130 stores information and an operation in which the communication interface 140 transmits information. Therefore, in the embodiment, transmitting information to the communication interface 140 and transmitting the information transmitted by the communication interface 140 to other devices may be included in the controller 120 controlling the communication interface 140.

The controller 120 may include at least one memory in which programs for performing the above-described operations and the operations described below are stored, and at least one processor for executing the stored programs.

The communication interface 140 may perform wired communication or wireless communication with the electronic device 10 to receive a request for information from the electronic device 10 or transmit necessary information to the electronic device 10.

For example, when the communication interface 140 performs wired communication with the electronic device 10, the communication interface 140 may include a connector inserted into a port of the electronic device 10. At this time, the connector of the communication interface 140 and the port of the electronic device 10 may have the same standard. For example, when the port of the electronic device 10 is a USB port, the connector of the communication interface 140 may be a USB connector.

When the communication interface 140 performs wireless communication with the electronic device 10, the communication interface 140 may include at least one of a wireless communication module and a short-range communication module.

The wireless communication module may include at least one of various wireless communication modules that can be connected to an Internet network through wireless communication methods such as Wi-Fi, Wireless broadband, Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), 4th generation (4G) mobile communication, and 5th generation (5G) mobile communication.

The short-range communication module may include at least one of various short-range communication modules such as a Bluetooth module, an infrared communication module, a radio frequency identification (RFID) communication module, a wireless local access network (WLAN) communication module, an NFC communication module, and a Zigbee communication module.

In addition, the communication interface 140 may receive information to be stored in the memory 130 by performing wired communication or wireless communication with other electronic devices as well as the electronic device 10 receiving the information stored in the memory 130.

For example, the communication interface 140 may be connected to the computer through wired communication or wireless communication to receive the management information such as network settings information, installation program files, or update information required by the electronic device 10. The transmitted information may be stored for each of the electronic devices 10 in the memory 130.

Referring to the example of FIG. 4, the management terminal 100 according to an embodiment may be implemented in a form in which an input device capable of inputting the ID into a USB memory is combined. The input device coupled to the USB memory may be the ID inputter 110 of the management terminal 100.

The communication interface 140 may include a USB connector 141 formed on one end of a main body 101. The USB connector 141 may be inserted into the USB port provided in the electronic device 10.

The ID inputter 110 may include a dial 111 rotatably formed on the main body 101. In the example of FIG. 4, it is exemplified that four of the dials 111 having numbers from 0 to 9 are formed, such as a dial-type lock, to receive an ID of a 4-digit number, but the management terminal 100 may be used as an example. The embodiment is not limited to this. The number of the dials 111 may be less than four, or may exceed four, and it is also possible to form the dial 111 having non-numeric characters.

Alternatively, as illustrated in FIG. 5, ten buttons 112 each having a number from 0 to 9 may be formed in the main body 101 like a button-type lock. Likewise, it is also possible that the button 112 having a character other than a number is formed.

Alternatively, the ID inputter 110 may be implemented in a form of the touch pad. The ID inputter 110 of the management terminal 100 according to an embodiment only needs to receive the ID stored in the memory 130, and the implementation example is not limited.

Hereinafter, the operation of the management terminal 100 according to an embodiment will be described in detail, for example, when the management terminal 100 has the structure illustrated in FIG. 4 and is used to set the network of the TV installed in a hotel room.

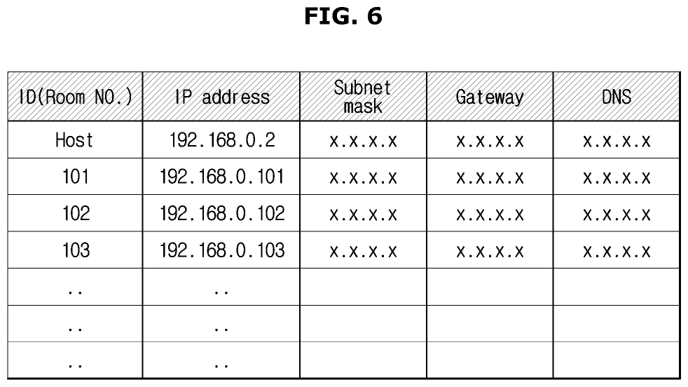

FIG. 6 is a table illustrating an example of information that may be stored in a memory of a management terminal according to an embodiment.

The TV installed in the hotel room may be connected to the management server 20 through the network using a unique IP address assigned to each of the rooms. Accordingly, as illustrated in FIG. 6, the memory 130 may match and store information regarding the IP address, the subnet mask, the gateway, the DNS, etc. assigned to a corresponding room for each of the room numbers. Here, the room number may be the ID for identifying the TV installed in the room.

It is also possible that the full management information is stored in one file, and the management information matched to each of the IDs may be stored in separate files. In the embodiment, the format in which the management information is stored is not limited.

The information illustrated in FIG. 6 is only an example of information that can be stored in the memory 130, and information necessary for the network settings is not limited thereto. If the information is necessary for the network settings of the TV installed in the hotel room, it may be stored in advance in the memory 130 even if the information is not illustrated in FIG. 6.

As described above, the information stored in the memory 130 may be received from the outside through the communication interface 140. For example, in the management terminal 100 having the structure of FIG. 4, when the USB connector 141 is inserted into the USB port of the computer, the computer may transmit the information necessary for the network settings of the TVs installed in each of the rooms to the management terminal 100. The transmitted information may be stored in the memory 130.

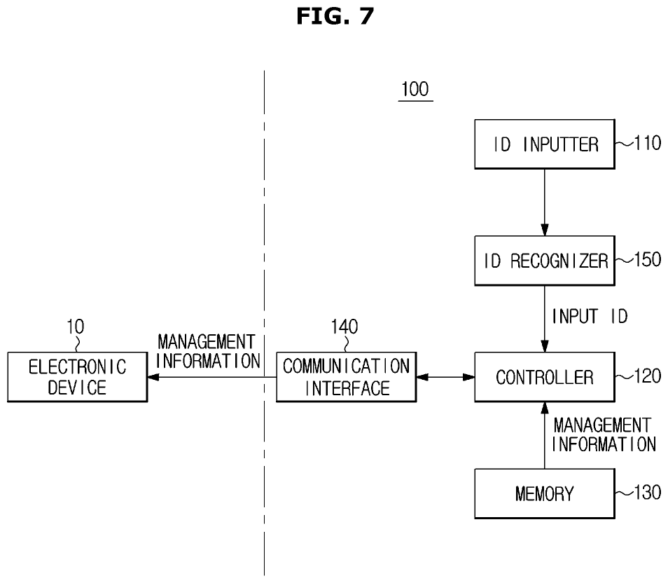

FIG. 7 is a control block diagram of a management terminal further comprising an ID recognizer.

Referring to FIG. 7, the management terminal 100 may further include an ID recognizer 150 that recognizes the ID input to the ID inputter 110. For example, when the ID inputter 110 is implemented in the form of a dial or a button, the ID recognizer 150 may include circuits for recognizing numbers or letters input to the ID inputter 110 and their input order.

The controller 120 may transmit an ID recognition command to the ID recognizer 150 to control the ID recognizer 150 to recognize the ID input to the ID inputter 110. When the ID recognizer 150 transmits the input ID to the controller 120, the controller 120 may search for and retrieve management information corresponding to the ID input from the memory 130.

The management information corresponding to the input ID may be transmitted to the electronic device 10 through the communication interface 140.

Alternatively, it is also possible to transmit the electronic device 10 through the communication interface 140 together with the full management information.

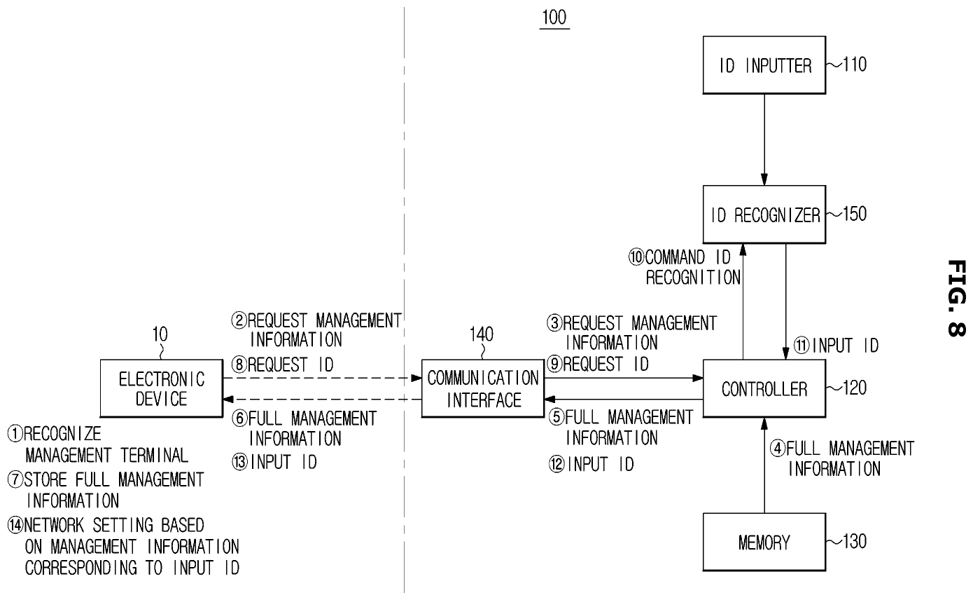

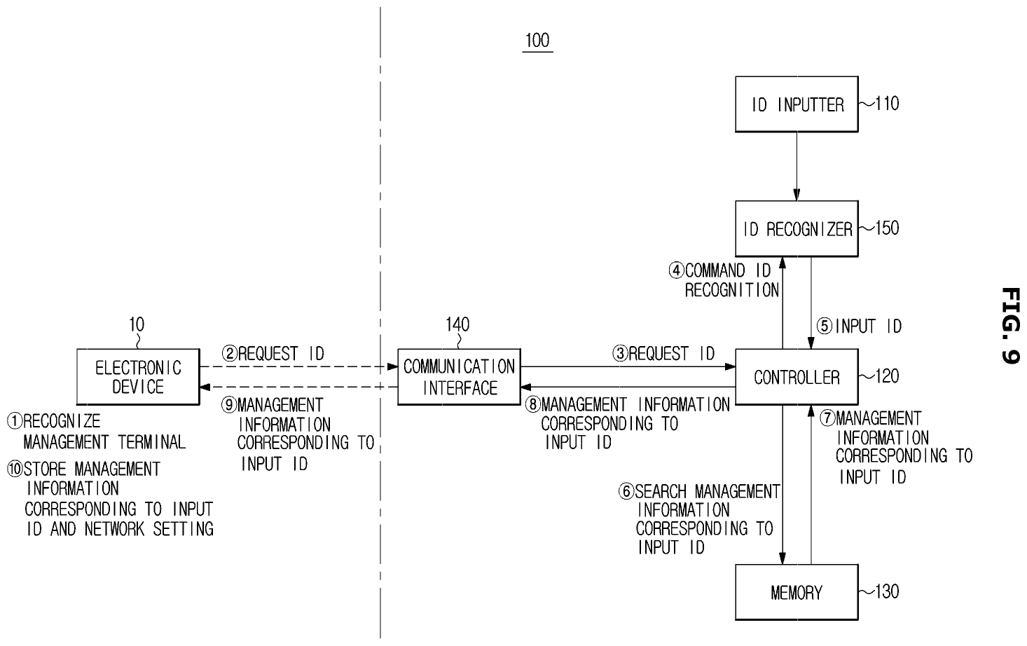

FIGS. 8 and 9 are views illustrating examples of operations performed by components of a management terminal when the management terminal transmits management information to electronic devices. In the examples of FIGS. 8 and 9, it is assumed that the user inputs the ID of the TV 11 that is currently a management target to the management terminal 100 and connects the management terminal 100 to the TV 11.

Referring to FIG. 8, when the USB connector 141 is inserted into the USB port provided on the TV 11, the TV 11 may \textcircled{1} recognize the management terminal 100. Further, power may be supplied from the TV 11 to the management terminal 100, and a magnitude of the supplied power may be determined by a predetermined standard. For example, 5V power may be supplied.

The TV 11 may transmit \textcircled{2} a request for the management information stored in the memory 130 of the management terminal 100 to the communication interface 140. Here, the management information may include the network settings information such as the IP address, the subnet mask, the gateway, and the DNS assigned to the plurality of rooms, as illustrated in FIG. 6 described above.

The communication interface 140 may transmit the request for \textcircled{3} the management information input from the TV 11 to the controller 120. When the request for the management information is transmitted from the communication interface 140, the controller 120 may retrieve \textcircled{4} the management information stored in the memory 130 and transmit the management information to \textcircled{5} the communication interface 140. At this time, the transmitted management information may be the full management information.

The communication interface 140 may transmit \textcircled{7} the full management information transmitted to the TV 11, and the TV 11 may store \textcircled{8} the full management information transmitted from the management terminal 100.

The TV 11 may transmit \textcircled{8} an ID request to the communication interface 140. The communication interface 140 may transmit \textcircled{9} the ID request to the controller 120, and the controller 120 may command \textcircled{10} ID recognition to the ID recognizer 150.

When the ID recognizer 150 recognizes the ID input to the ID inputter 110 and transmits \textcircled{11} the input ID to the controller 120, the controller 120 may transmit \textcircled{12} the input ID to the communication interface 140, and the communication interface 140 may transmit \textcircled{13} the input ID to the TV 11.

The TV 11 receiving the ID may search for and extract network settings information corresponding to the transmitted ID from \textcircled{14} the stored management information, and may perform network settings based on the extracted network settings information.

When performing the network settings of the TV 11, information about a host, which is a target connected through the network, may also be required. Therefore, of course, the network settings information corresponding to the host may be included in the network settings information corresponding to the ID.

Meanwhile, instead of transmitting the full management information to the TV 11, it is also possible to transmit only the network settings information corresponding to the TV 11. Hereinafter, a related example will be described with reference to FIG. 9.

Referring to FIG. 9, when the USB connector 141 is inserted into the USB port provided on the TV 11, the TV 11 may recognize \textcircled{1} the management terminal 100. As described above, it is also possible to supply power to the management terminal 100 from the TV 11.

The TV 11 may transmit \textcircled{2} the ID request to the communication interface 140. The communication interface 140 may transmit \textcircled{3} the ID request to the controller 120, and the controller 120 may command \textcircled{4} ID recognition to the ID recognizer 150.

When the ID recognizer 150 recognizes the ID input to the ID inputter 110 and transmits \textcircled{5} the input ID to the controller 120, the controller 120 may search for the management information corresponding to \textcircled{6} the input ID from the memory 130. When the management information corresponding to the input ID is searched, the controller 120 may search for \textcircled{7} the searched management information.

The controller 120 may transmit \textcircled{8} the management information corresponding to the input ID to the communication interface 140, and the communication interface 140 may transmit the management information corresponding to \textcircled{9} the input ID to the TV 11.

The TV 11 may store \textcircled{10} the transmitted management information and perform the network settings based on the stored management information.

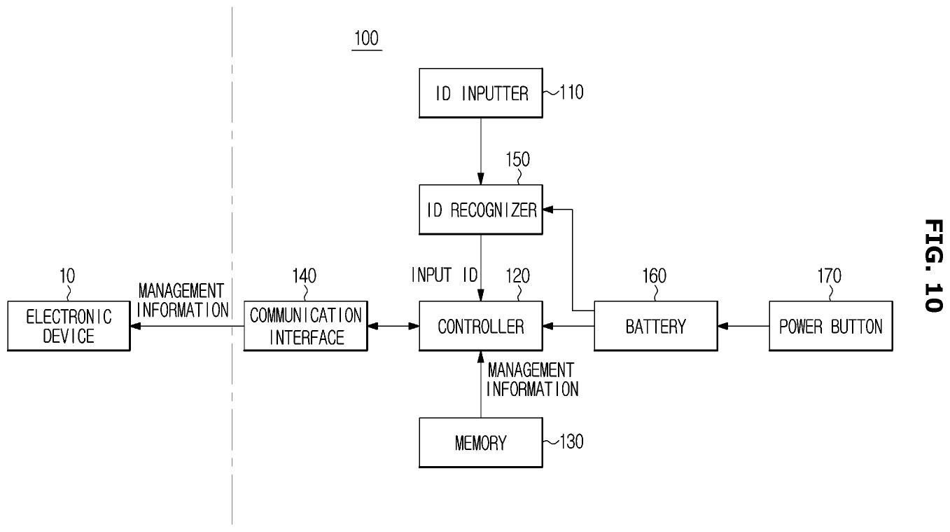

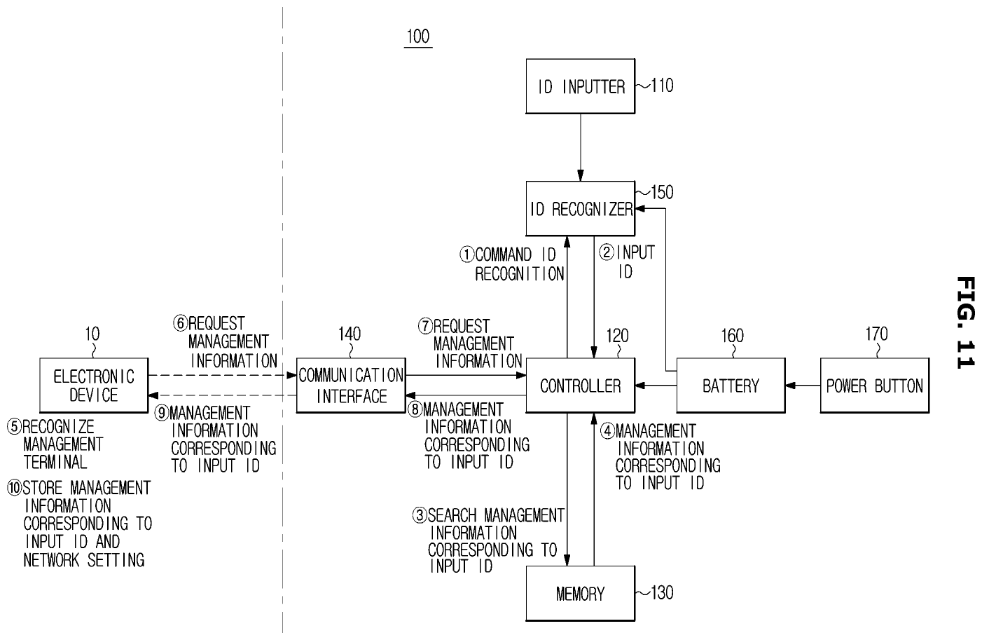

FIG. 10 is a control block diagram of a management terminal including a battery, and FIG. 11 is a view illustrating examples of operations performed by components of a management terminal when the management terminal including a battery transmits a file to an electronic device.

Referring to FIG. 10, the management terminal 100 may further include a battery 160 for supplying power and a power button 170 for receiving an on/off command of power from the user.

The battery 160 may be a primary battery that needs to be replaced when it reaches its end of life, or a secondary battery that can be recharged and reused.

The power button 170 may be formed in an area of the main body 101, and the user may turn on/off the power of the management terminal 100 by operating the power button 170.

As illustrated in FIG. 10, in the case in which the management terminal 100 is provided with the separate battery 160, when the management terminal 100 is powered, it may perform some of the above operations even if it is not connected to the TV 11.

The operation after the power of the management terminal 100 is turned on and the user inputs the ID of the TV 11, which is the current management target, to the ID inputter 110 will be described.

Referring to FIG. 11, the controller 120 may command the ID recognition to the ID recognizer 150, and the ID recognizer 150 may recognize the ID input to the ID inputter 110.

The ID recognizer 150 may transmit \textcircled{2} the input ID to the controller 120, and the controller 120 may search for the management information corresponding to \textcircled{3} the input ID from the memory 130, and may retrieve the management information corresponding to \textcircled{4} the input ID.

When the USB connector 141 is inserted into the USB port provided on the TV 11, the TV 11 may recognize \textcircled{5} the management terminal 100. The TV 11 may transmit the request for \textcircled{6} the management information to the communication interface 140.

The communication interface 140 may transmit the request for \textcircled{7} the management information transmitted from the TV 11 to the controller 120, and the controller 120 may transmit the management information corresponding to \textcircled{8} the input ID to the communication interface 140.

The communication interface 140 may transmit the management information corresponding to \textcircled{9} the input ID to the TV 11. The TV 11 may store \textcircled{10} the transmitted management information and perform the network settings based on the stored management information.

Alternatively, when the power of the management terminal 100 is turned on, only the ID recognition may be performed. When a request for a configuration file is transmitted from the TV 11, it is also possible to transmit the ID recognized by the ID recognizer 150 and the full management information stored in the memory 130 to the TV 11 in response.

In this case, the TV 11 may extract the management information corresponding to the ID recognized by the ID recognizer 150 from the transmitted full management information, and may perform the network settings based on the extracted management information.

According to the examples of FIGS. 8 to 11 described above, after the user enters the room number in the management terminal 100 and simply connects the management terminal 100 to the TV installed in the room, the management terminal 100 may automatically input the network settings information to the TV 11, thereby reducing the user's work load and working time and preventing errors in input due to manual input.

In addition, when only the power of the TV 11 is turned on while the management terminal 100 is connected to the TV 11, since the subsequent operations can be automatically performed by the TV 11 and the management terminal 100, it is possible for the user to perform other tasks without waiting for the TV 11 to finish booting.

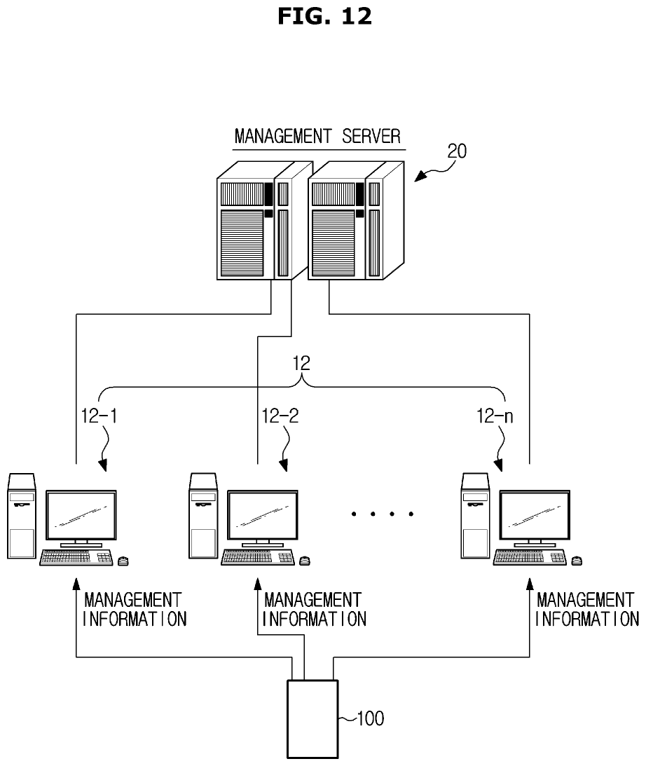

FIG. 12 is a view illustrating a case in which an electronic device managed by a management terminal according to an embodiment is a computer.

As illustrated in FIG. 12, the electronic device 10 may include computers 12-1, 12-2, . . . , 12-n used in an office space.

In this case, the management information stored in the memory 130 of the management terminal 100 may include the network settings information for connecting a plurality of computers 12 to the management server 20 through the network.

Alternatively, it is also possible that the management information stored in the memory 130 includes a program that should be installed in each of the computers 12. Particularly, a program file to be installed in a computer 1 12-1 and a program file to be installed in a computer 2 12-1 to a program file to be installed in a computer n 12-n may be stored in the memory 130.

Alternatively, the management information stored in the memory 130 may include update information of the programs installed in each of the computers 12.

The ID capable of identifying the plurality of computers 12 may be previously defined, and the management information corresponding to each of the computers 12-n may be stored in the memory 130 by matching the ID of the corresponding computer.

The only difference is that contents of information stored in the memory 130 and a target of information transmission are computers, and the series of processes in which the user described above inputs the ID of the TV 11 through the ID inputter 110, the ID recognizer 150 recognizes the input ID, and the controller searches for the management information corresponding to the input ID in the memory 130 and transmits the management information to the TV 11 through the communication interface 140 is equally applicable even when the electronic device 10 is the computer 12.

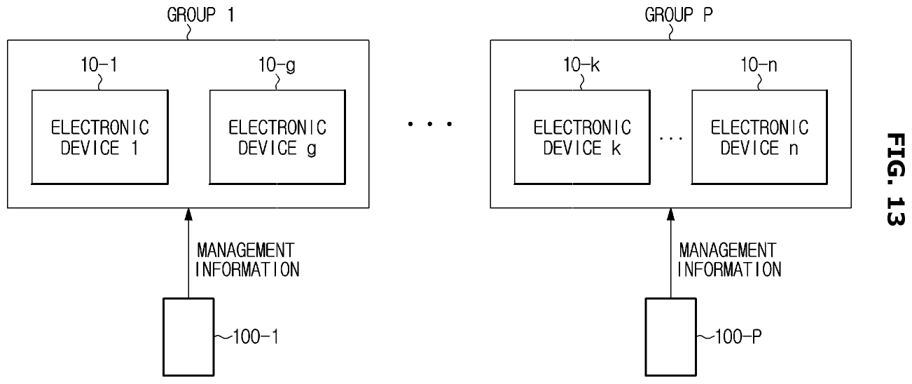

FIG. 13 is a view illustrating a case in which a management terminal according to an embodiment divides and manages electronic devices into a plurality of groups.

Referring to FIG. 13, it is also possible to divide the plurality of electronic devices 10 into a plurality of groups, and manage the electronic devices 10 belonging to each of the groups using different management terminals 100-1, . . . , 100-p (p is an integer of 2 or more).

Particularly, n electronic devices 10-1, . . . , 10-n are divided into p groups, and a management terminal 1 100-1 may manage an electronic device g 10-g from the electronic device 1 10-1 belonging to group 1. In the memory 130 of the management terminal 1 100-1, management information of the electronic device g 10-g from the electronic device 1 10-1 may be stored.

A management terminal p 100-p may manage the electronic device n 10-n from an electronic device k 10-k belonging to group p. In the memory 130 of the management terminal p 100-p, management information of the electronic device n 10-n from the electronic device k 10-k may be stored. The same description may be applied to a group belonging between the group 1 and the group p.

For example, when the management terminal 100 manages the TVs 11 installed in each of the rooms of the hotel, the electronic devices may be grouped for each floor of the hotel. The user may connect the management terminal 100 in which the management information corresponding to the electronic devices on the floor to the TV 11 installed in one of a plurality of the rooms located on each of the floors is stored, so that the necessary management information is automatically input to the TV 11. The user does not need to wait for the TV 11 to finish booting, so the user can move to work on another one of the floors.

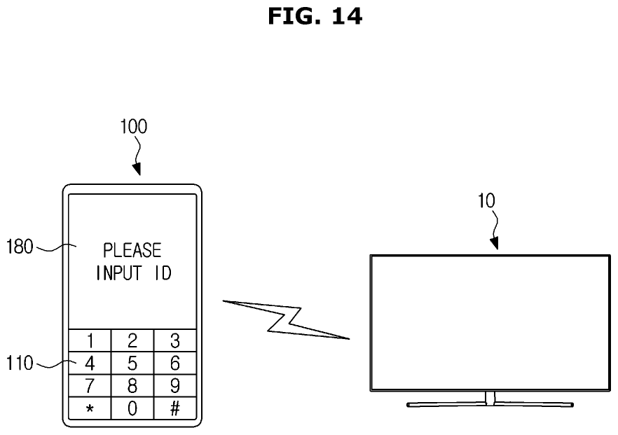

FIG. 14 is a view illustrating another example of a management terminal according to an embodiment.

In the above-described example, the case where the management terminal 100 is implemented in a form in which the input device is coupled to the USB memory has been described. In another example, as illustrated in FIG. 14, it is also possible that the management terminal 100 is implemented as a mobile device. Here, the mobile device may refer to a device capable of carrying and storing data such as a smart phone, a Personal Digital Assistant (PDA), a laptop computer, and the like, which can exchange data with other electronic devices through wireless communication.

Even when the management terminal 100 is implemented as the mobile device, the control block diagram of FIG. 3 described above may be applied. However, when the management terminal 100 is implemented as the mobile device, a display 180 may be further included as illustrated in FIG. 14, and a screen for guiding the ID input of the electronic device 10 may be displayed on the display 180.

The ID inputter 110 may be implemented by the input device such as a button or touch pad formed on the mobile device.

Meanwhile, when the management terminal 100 is implemented as the mobile device, a program for performing the operation of the controller 120 may be stored in advance in the controller 120 or may be provided from another recording medium.

For example, a program for performing the operation of the controller 120 that recognizes the input ID, searches for the information corresponding to the input ID from the memory 130 and transmits the information to the electronic device 10, or recognizes the input ID and transmits full information stored in the memory 130 and the input ID to the electronic device 10 may be stored in the controller 120 when the management terminal 100 is manufactured.

In the latter case, a recording medium in which the program for performing the above-described operation is stored is included in a remote server, and the management terminal 100 may download the program for performing the above-described operation from the recording medium included in the remote server.

Alternatively, the recording medium in which the program for performing the above-described operation is stored may be embodied as a portable recording medium such as an optical disk, a hard disk, or USB memory. In this case, the management terminal 100 may read a program that performs the above-described operation from the recording medium.

The program performing the above-described operation may be provided to the management terminal 100 in the form of an application. In this case, when the user selects the corresponding application in the management terminal 100, the controller 120 may execute the provided program to perform the above-described operations.

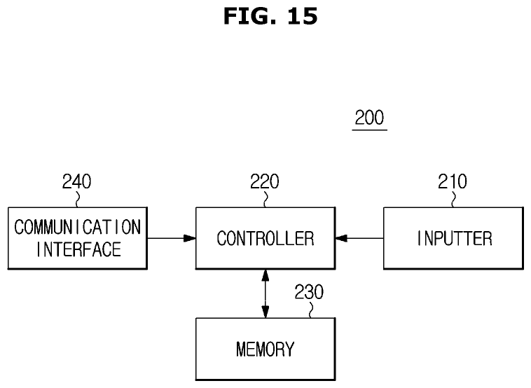

FIG. 15 is a control block diagram of an electronic device according to an embodiment.

An electronic device 200 according to the embodiment may include the electronic device 10 described above. Accordingly, the electronic device 200 may include an electronic device that needs the network settings such as the TV or the computer, needs to install a specific program, or needs to update the version of the program.

The components and operations of the electronic device 200 will be described based on the foregoing.

Referring to FIG. 15, the electronic device 200 may be connected to the management terminal 100 by wire or wirelessly, and may include a communication interface 240 for requesting transmission of the management information corresponding to the plurality of IDs stored in the management terminal 100 and the ID input to the management terminal 100, a memory 230 for storing the management information corresponding to the plurality of transmitted IDs when the management information corresponding to the plurality of IDs is transmitted from the management terminal 100, and a controller 220 for searching the management information corresponding to the ID input to the management terminal 100 and performs a predefined operation based on the searched management information.

The communication interface 240 may perform wired communication or wireless communication with the management terminal 100 to transmit a request for information to the management terminal 100 or receive necessary information from the management terminal 100.

For example, when the communication interface 240 performs wired communication with the management terminal 100, the communication interface 240 may include a port into which the connector of the management terminal 100 is inserted. At this time, the port of the communication interface 240 and the connector of the management terminal 100 may have the same standard. For example, when the connector of the management terminal 100 is the USB connector, the communication interface 240 may include the USB port.

When the communication interface 240 performs wireless communication with the management terminal 100, the communication interface 240 may include at least one of the wireless communication module and the short-range communication module.

The wireless communication module may include at least one of various wireless communication modules that can be connected to the Internet network through wireless communication methods such as Wi-Fi, Wireless broadband, Global System for Mobile Communication (GSM), Code Division Multiple Access (CDMA), Wideband Code Division Multiple Access (WCDMA), Universal Mobile Telecommunications System (UMTS), Time Division Multiple Access (TDMA), Long Term Evolution (LTE), 4th generation (4G) mobile communication, and 5th generation (5G) mobile communication.

The short-range communication module may include at least one of various short-range communication modules such as a Bluetooth module, an infrared communication module, a radio frequency identification (RFID) communication module, a wireless local access network (WLAN) communication module, an NFC communication module, and a Zigbee communication module.

The controller 220 may include at least one memory in which programs for performing the operations described below are stored, and at least one processor for executing the stored programs.

The memory 230 may include a non-volatile memory that retains the stored data even when the power supply is interrupted. For example, the memory 230 may include at least one of read only memory (ROM), erasable programmable ROM (EPROM), electrically erasable programmable ROM (EEPROM), flash memory, and solid state drive (SSD) that temporarily stores data.

In addition, the memory 230 may further include a volatile memory that loses stored data when the power supply is interrupted. For example, the memory 230 may include at least one of static random access memory (S-RAM) and dynamic random access memory (D-RAM) that temporarily store data.

Referring to FIG. 8 described above, when the management terminal 100 is connected to the electronic device 200 through the communication interface 240, the controller 220 may recognize that the management terminal 100 is connected, and may request the management information from the management terminal 100 through the communication interface 240. When the electronic device 200 does not know its ID, the controller 220 may request the management information corresponding to the entirely of IDs from the management terminal 100, that is, the full management information.

When the communication interface 240 receives the full management information from the management terminal 100, the controller 220 may store the full management information in the memory 230. The full management information may be stored non-temporarily or temporarily.

The controller 220 may request the ID of the electronic device 200 to the management terminal 100 through the communication interface 240. As described above, the ID recognizer 150 of the management terminal 100 may recognize the ID input to the ID inputter 110, and the communication interface 140 of the management terminal 100 may transmit the recognized ID to the communication interface 240 of the electronic device 200.

When the communication interface 240 receives the ID from the management terminal 100, the controller 220 may search for and extract the management information corresponding to the received ID from the full management information stored in the memory 230.

The controller 220 may perform a predefined operation using the management information corresponding to the received ID. For example, the network settings may be performed based on the management information corresponding to the ID, the program may be installed, or a version of the installed program may be updated. There is no limitation on the operation performed by the controller 220 based on the management information.

Meanwhile, as illustrated in FIG. 9 described above, it is also possible for the electronic device 200 to receive only the management information corresponding to the ID of the electronic device 200 from the management terminal 100. It is also possible for the controller 220 to request ID transmission to the management terminal 100 through the communication interface 240. Regardless of the request of the electronic device 200, the management terminal 100 may recognize the ID input to the ID inputter 110 and transmit the management information corresponding to the recognized ID to the electronic device 200.

After obtaining the necessary management information from the management terminal 100, the electronic device 200 may perform the predefined operation even if the management terminal 100 is not connected. Accordingly, when the reception of the full management information and the ID from the management terminal 100 is completed or the reception of the management information corresponding to the ID of the electronic device 200 is completed, the electronic device 200 may output a notification visually or audibly to inform the user that the connection between the management terminal 100 and the electronic device 200 may be released.

When the notification is output, the user may separate the management terminal 100 from the electronic device 200 and use the separated management terminal 100 in another electronic device. Accordingly, the time required to manage the plurality of electronic devices 200 may be reduced.

As long as the electronic device 200 is powered on, the controller 220 may recognize the management terminal 100 and automatically request the necessary management information to the management terminal 100 even if the user does not execute a separate menu in the electronic device 200. In addition, when the necessary management information is received from the management terminal 100, the controller 220 may automatically perform the predefined operation based on the received setting information.

In addition, when performing the predefined operation, since the user does not need to manually input the necessary setting information by operating the inputter 210, the user only needs to connect the management terminal 100 to the electronic device 200 and turn on the power of the electronic device 200, and no additional work is required.

Hereinafter, a method of managing the electronic device according to the embodiment will be described. In implementing the method of managing the electronic device, the management terminal 100 and the electronic device 200 according to the above-described embodiment may be used. Accordingly, the description of FIGS. 1 to 15 described above may be applied to the method of managing the electronic device even if there is no special mention.

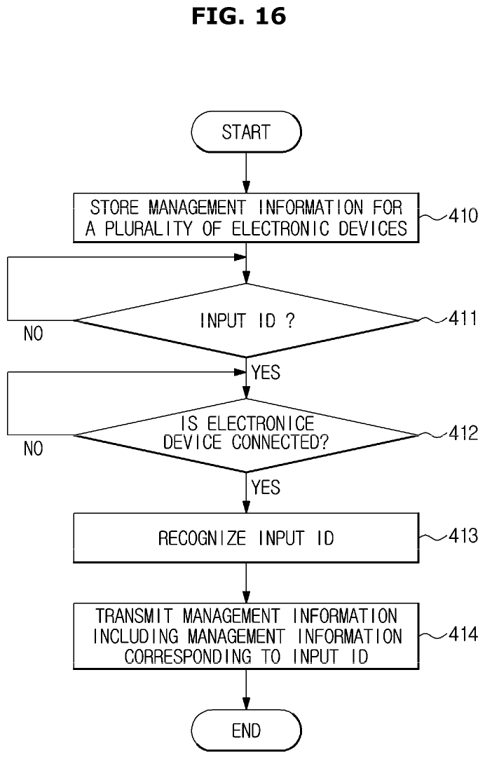

FIG. 16 is a flowchart illustrating an example of a method of managing an electronic device according to an embodiment. The example of FIG. 16 illustrates the operations performed by the management terminal 100.

Referring to FIG. 16, the management information for the plurality of electronic devices 10 may be stored in the memory 130 in association with the IDs that identify the plurality of electronic devices 10 (410). The management information for the plurality of electronic devices 10 may be input from an external computer connected to the management terminal 100 by wire or wirelessly. There may be a time difference between the storage of the management information for the electronic device 10 and the operations described below.

When the ID is input to the ID inputter 110 of the management terminal 100 (YES in 411), and the management terminal 100 is connected to the electronic device 10 (YES in 412), the ID recognizer 150 may recognize the ID input to the ID inputter 110 (413). The input ID may be the ID that identifies the electronic device 10. The recognition of the input ID may be made at the request of the electronic device 10, or may be made irrespective of the request of the electronic device 10.

Meanwhile, when the management terminal 100 is connected to the electronic device 10, the management terminal 100 may be supplied power from the electronic device 10. When power is supplied, the ID recognizer 150, the controller 120, and the communication interface 140 of the management terminal 100 may operate.

The management information corresponding to the input ID may be transmitted to the electronic device 10 (414). The transmitted management information may be the full management information, or may include only the management information corresponding to the input ID. The management information may be transmitted at the request of the electronic device 10 or may be made irrespective of the request of the electronic device 10. The electronic device 10 may store the management information transmitted from the management terminal 100.

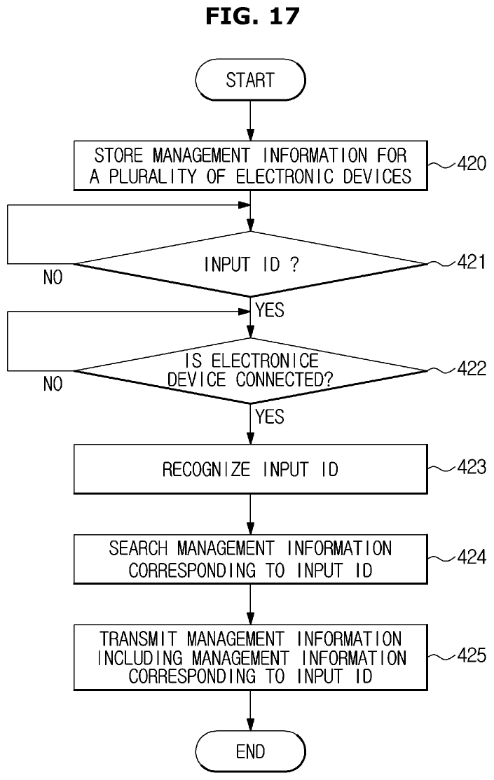

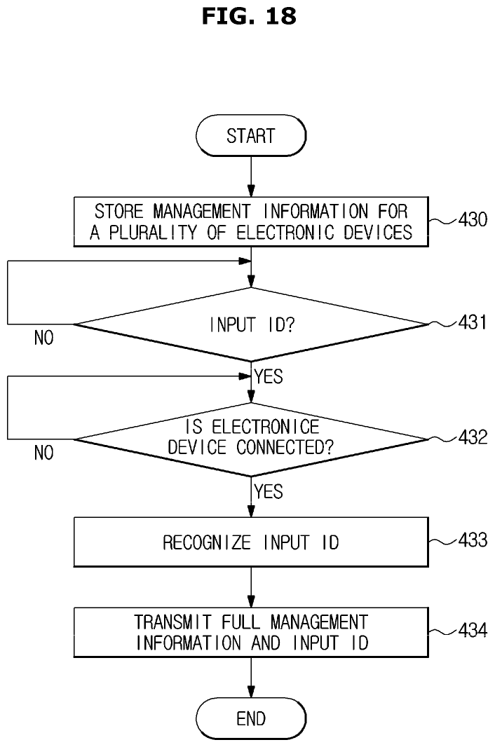

FIGS. 17 and 18 are flowcharts embodying an example of a method of managing an electronic device according to an embodiment.

Referring to FIG. 17, the management information for the plurality of electronic devices 10 may be stored in the memory 130 in correspondence with the IDs that identify the plurality of electronic devices 10 (420).

When the ID is input to the ID inputter 110 of the management terminal 100 (YES in 421), and the management terminal 100 is connected to the electronic device 10 (YES in 422), the ID recognizer 150 may recognize the ID input to the ID inputter 110 (423).

The controller 120 may search for the management information corresponding to the ID input from the memory 130 (424), and may transmit the management information corresponding to the input ID to the electronic device 10 (425). The recognition of the input ID or transmission of the management information corresponding to the input ID may be performed by the request of the electronic device 10 or may be made irrespective of the request of the electronic device 10. The electronic device 10 that has received the management information corresponding to its ID may automatically perform the predefined operation such as the network settings, the program installation, or the version update based on the transmitted management information.

Referring to FIG. 18, the management information for the plurality of electronic devices 10 may be stored in the memory 130 in association with the IDs that identify the plurality of electronic devices 10 (430).

When the ID is input to the ID inputter 110 of the management terminal 100 (YES in 431), and the management terminal 100 is connected to the electronic device 10 (YES in 432), the ID recognizer 150 may recognize the ID input to the ID inputter 110 (433).

The controller 120 may transmit the full management information and the input ID to the electronic device 10 (434). The transmission of the full management information and the input ID may also be made at the request of the electronic device 10, or may be made irrespective of the request of the electronic device 10. Further, the full management information and the input ID may be transmitted separately or may be transmitted together.

The electronic device 10 receiving the full management information and the input ID may perform a predefined operation using the management information corresponding to the input ID among the full management information.

On the other hand, when the battery 160 is provided in the management terminal 100, even if power is not applied from the electronic device 10, when the power of the management terminal 100 is turned on, the ID recognizer 150 may recognize the ID input to the ID inputter 110, and the controller 120 may search for the management information corresponding to the ID input from the memory 130. When the management terminal 100 is connected to the electronic device 10 and the request for transmission of the management information is input from the electronic device 10, the management terminal 100 may transmit the management information corresponding to the ID to the electronic device 10.

Alternatively, even when the management terminal 100 includes the battery 160, it is also possible to transmit the full management information and the input ID to the electronic device 10, and the electronic device 10 may search and use the management information corresponding to the ID from the full management information.

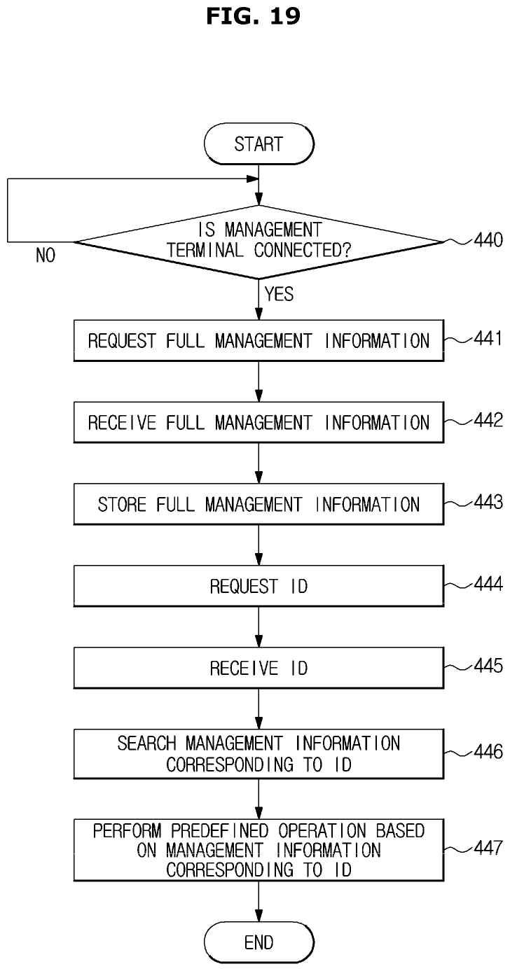

FIG. 19 is a flowchart illustrating an operation performed by an electronic device in a method of managing the electronic device according to an embodiment.

Referring to FIG. 19, when the management terminal 100 is connected (YES in 440), the controller 220 of the electronic device 200 may recognize that the management terminal 100 is connected and may request the full management information to the management terminal 100 through the communication interface 240 (441).

When the management terminal 100 transmits the full management information stored in the memory 130 in response to the request of the electronic device 200, the communication interface 240 may receive the full management information (442), and the memory 230 may store the received full management information (443).

The controller 220 may request the ID from the management terminal 100 through the communication interface 240 (444). Here, the requested ID may be the ID of the electronic device 200 itself, and the management terminal 100 may estimate the ID input to the ID inputter 110 as the ID of the electronic device 200 and transmit the ID to the electronic device 200.

The communication interface 240 may receive the ID (445), and the controller 220 may search for the management information corresponding to the ID from the full management information stored in the memory 230 (446).

The controller 220 may perform predefined operations such as the network settings, the program installation, the version update, etc. based on the management information corresponding to the ID (447).

Meanwhile, it is also possible for the electronic device 200 to receive only the management information corresponding to the ID of the electronic device 200 from the management terminal 100. It is also possible for the controller 220 to request ID transmission to the management terminal 100 through the communication interface 240, and the management terminal 100 is input to the ID inputter 110 regardless of the request of the electronic device 200. It is also possible to recognize the identified ID and transmit the management information corresponding to the recognized ID to the electronic device 200.

Needless to say, each of the steps illustrated in the flowcharts of FIGS. 17 to 19 described above may be reversed as necessary, and other operations necessary between the steps may be further performed.

According to the management terminal, the electronic device, and the method of managing the electronic device according to the above-described embodiment, the electronic device may recognize the management terminal and receive the necessary information from the management terminal even if the user does not execute the separate menu in the electronic device. In addition, when the necessary information is received from the management terminal, the predefined operation may be automatically performed based on the received information.

In addition, when performing the predefined operation, the user only needs to connect the management terminal to the electronic device and turn on the power of the electronic device, and additional work such as manually inputting the necessary information is not required. In this way, the user's workload and working time may be reduced, and errors in input due to manual input may be prevented.

Meanwhile, the disclosed embodiments may be implemented in the form of a recording medium storing instructions that are executable by a computer. The instructions may be stored in the form of a program code, and when executed by a processor, the instructions may generate a program module to perform operations of the disclosed embodiments. The recording medium may be implemented as a computer-readable recording medium.

The computer-readable recording medium may include all kinds of recording media storing commands that can be interpreted by a computer. For example, the computer-readable recording medium may be read only memory (ROM), random access memory (RAM), a magnetic tape, a magnetic disc, flash memory, an optical data storage device, etc.

Although a few embodiments of the disclosure have been shown and described, it would be appreciated by those skilled in the art that changes may be made in these embodiments without departing from the principles and spirit of the disclosure, the scope of which is defined in the claims and their equivalents.

1. A management terminal comprising:
an ID inputter configured to receive an ID of an electronic device from a user;
a memory configured to store management information for a plurality of the electronic devices in association with a plurality of the IDs for identifying the plurality of electronic devices, when the management information for the plurality of electronic devices is input;
a communication interface connected to at least one of the plurality of electronic devices by wire or wirelessly; and
a controller configured to control the communication interface to transmit the management information stored in the memory to the electronic device connected to the communication interface.

2. The management terminal according to claim 1, wherein the controller is configured to search the management information corresponding to the ID input to the ID inputter from the memory.

3. The management terminal according to claim 2, wherein the communication interface is configured to transmit the management information corresponding to the input ID to the electronic device connected to the communication interface.

4. The management terminal according to claim 1, wherein the communication interface is configured to transmit the management information corresponding to the plurality of IDs and the IDs input to the ID inputter to the electronic device connected to the communication interface.

5. The management terminal according to claim 1, further comprising:
a battery configured to supply power;
a power button configured to receive a power on/off command from the user; and
an ID recognizer configured to recognize the ID input to the ID inputter.

6. The management terminal according to claim 5, wherein, when the on command is input to the power button, the controller is configured to control the ID recognizer to recognize the ID input to the ID inputter.

7. The management terminal according to claim 6, wherein the controller is configured to search for the management information corresponding to the ID input to the ID inputter in the memory.

8. The management terminal according to claim 7, wherein, when the electronic device is connected to the communication interface, the controller is configured to control the communication interface to transmit the management information corresponding to the ID input to the ID inputter to the connected electronic device.

9. The management terminal according to claim 6, wherein, when the electronic device is connected to the communication interface, the controller is configured to control the communication interface to transmit the management information corresponding to the plurality of IDs and the ID input to the ID inputter to the connected electronic device.

10. An electronic device comprising:
a communication interface connected to a management terminal by wire or wirelessly, and configured to request transmission of management information corresponding to a plurality of IDs stored in the management terminal and the ID input to the management terminal;
a memory configured to store the management information corresponding to the transmitted plurality of IDs when the management information corresponding to the plurality of IDs is transmitted from the management terminal; and
a controller configured to search for the management information corresponding to the IDs input to the management terminal from the memory, and to perform a predefined setting operation based on the searched management information.

11. The electronic device according to claim 10, wherein the management information comprises at least one of network settings information used for network settings of the electronic device, a program installed in the electronic device, and information for updating a version of the program installed in the electronic device.

12. The electronic device according to claim 10, wherein, when the management information corresponding to the plurality of IDs and the IDs input to the management terminal are transmitted from the management terminal, the controller is configured to output a notification visually or audibly.

13. A method of managing an electronic device comprising:
storing management information for a plurality of the electronic devices corresponding to a plurality of IDs identifying the plurality of electronic devices, respectively;
receiving the ID of the electronic device from a user; and
transmitting the management information including the management information corresponding to the input ID to the electronic device wired or wirelessly connected to a management terminal among the plurality of electronic devices.

14. The method according to claim 13, further comprising:
searching for the management information corresponding to the ID input to an ID inputter among the stored management information,
wherein the transmitting of the management information comprises:
transmitting the management information corresponding to the input ID to the electronic device connected to the management terminal.

15. The method according to claim 13, wherein the transmitting of the stored management information comprises:
transmitting the management information corresponding to the plurality of IDs and the input ID to the electronic device connected to the management terminal.
